(19) United States
(12) Patent Application Publication
(10) Pub. No.: US 2026/0103200 A1
(43) Pub. Date: Apr. 16, 2026

(54) TIRE MODEL INCORPORATION TO LINEAR TIME VARYING MODEL PREDICTIVE CONTROL

(71) Applicant: GM Global Technology Operations LLC, Detroit, MI (US)

(72) Inventors: Oded Yechiel, Rishon LeZion (IL); Avshalom Suissa, Ganei Tikva (IL)

(21) Appl. No.: 18/916,026

(22) Filed: Oct. 15, 2024

(51) Int. Cl. B60W 30/18; B60W 50/00; B60W 60/00

(52) U.S. Cl. CPC B60W 30/18172; B60W 50/0097; B60W 60/001; B60W 2050/0026; B60W 2520/105; B60W 2520/20; B60W 2552/40; B60W 2710/207

(57) ABSTRACT

An autonomous vehicle includes a system for operating the vehicle. A slip angle sensor measures a slip angle of a wheel of the autonomous vehicle. An accelerometer measures an acceleration of the autonomous vehicle. A steering actuator controls a steering angle of the autonomous vehicle. The processor determines a road friction coefficient of the at a selected prediction step, calculates a normal force for the autonomous vehicle from the acceleration, determines a wheel stiffness for the wheel for the normal force at the slip angle using the road friction coefficient based on a tire model for the wheel, calculates a steering command for the autonomous vehicle using a model predictive control having the wheel stiffness as input, and controls the steering actuator using the steering command to steer the autonomous vehicle.

The subject disclosure relates to the operation of autonomous vehicles and, in particular, to using up-to-date calculations of wheel stiffness in a model predictive control to generate a control command for the vehicle in a non-linear range of operation.

Autonomous vehicles use model predictive control to determine an appropriate control command, such as a steering command for the vehicle. The model predictive control uses a linear bicycle model that includes a constant value of front wheel stiffness and rear wheel stiffness. These constant values are suitable for generating a control command when the vehicle is operating in a linear range of operation. However, when the vehicle is operating in a non-linear range of operation (such as at a high slip angle, low road friction coefficient, etc.), these wheel stiffnesses are not adequately represented by constant values. Accordingly, it is desirable to provide a system and method for calculating a wheel stiffness and generating steering commands when the vehicle is operating in a non-linear range of operation.

### SUMMARY

In one exemplary embodiment, a method of operating a vehicle is disclosed. A slip angle of a wheel of the vehicle is determined at a selected prediction step during operation of the vehicle. A road friction coefficient of the wheel is determined. An acceleration of the vehicle is measured at the selected prediction step. A normal force for the vehicle at the selected prediction step is calculated from the acceleration. A wheel stiffness for the wheel is determined for the normal force at the slip angle using the road friction coefficient. A control input for the vehicle is generated using a model predictive control with the wheel stiffness as input. A processor controls the vehicle using the control input generated by the model predictive control.

In addition to one or more of the features described herein, the method further includes calculating the wheel stiffness by determining a slope of a characteristic curve of a tire model at the slip angle, wherein the characteristic curve corresponds to the road friction coefficient.

In addition to one or more of the features described herein, the method further includes calculating the wheel stiffness by calculating a derivative from values in a lateral force table for the wheel.

In addition to one or more of the features described herein, the method further includes calculating a system dynamics matrix for the vehicle using the wheel stiffness and optimizing the system dynamics matrix to generate the control input.

In addition to one or more of the features described herein, one of the wheel is a front wheel and the wheel stiffness is a front wheel stiffness and the wheel is a rear wheel and the wheel stiffness is a rear wheel stiffness.

In addition to one or more of the features described herein, the method further includes operating the vehicle in a non-linear range of operation.

In addition to one or more of the features described herein, the method further includes determining the wheel stiffness and the slip angle from measurements obtained while the vehicle is being operated.

In another exemplary embodiment, a system for operating an autonomous vehicle is disclosed. The system includes a sensor and a processor. The sensor measures a state parameter of the autonomous vehicle, the state parameter including a slip angle of a wheel of the autonomous vehicle and an acceleration of the autonomous vehicle. The processor is configured to determine a road friction coefficient of the wheel at a selected prediction step from the state parameter, calculate a normal force for the autonomous vehicle from the acceleration, determine a wheel stiffness for the wheel for the normal force at the slip angle using the road friction coefficient, generate a control input for the autonomous vehicle using a model predictive control having the wheel stiffness as input, and control the autonomous vehicle using the control input generated by the model predictive control.

In addition to one or more of the features described herein, the processor is further configured to calculate the wheel stiffness by determining a slope of a characteristic curve of a tire model at the slip angle, wherein the characteristic curve corresponds to the road friction coefficient.

In addition to one or more of the features described herein, the processor is further configured to calculate the wheel stiffness by calculating a derivative from values in a lateral force table for the wheel.

In addition to one or more of the features described herein, the processor is further configured to calculate a system dynamics matrix for the vehicle using the wheel stiffness and optimize the system dynamics matrix to generate the control input.

In addition to one or more of the features described herein, one of the wheel is a front wheel and the wheel stiffness is a front wheel stiffness and the wheel is a rear wheel and the wheel stiffness is a rear wheel stiffness.

In addition to one or more of the features described herein, the autonomous vehicle is operated in a non-linear range of operation.

In addition to one or more of the features described herein, the processor is further configured to determine the wheel stiffness and the slip angle from measurements obtained while the autonomous vehicle is being operated.

In yet another exemplary embodiment, an autonomous vehicle is disclosed. The autonomous vehicle includes a slip angle sensor for measuring a slip angle of a wheel of the autonomous vehicle, an accelerometer for measuring an acceleration of the autonomous vehicle, a steering actuator for controlling a steering angle of the autonomous vehicle, and a processor. The processor is configured to determine a road friction coefficient of the wheel at a selected prediction step, calculate a normal force for the autonomous vehicle from the acceleration, determine a wheel stiffness for the wheel for the normal force at the slip angle using the road friction coefficient based on a tire model for the wheel, calculate a steering command for the autonomous vehicle using a model predictive control having the wheel stiffness as input, and control the steering actuator using the steering command to steer the autonomous vehicle.

In addition to one or more of the features described herein, the processor is further configured to calculate the wheel stiffness by determining a slope of a characteristic curve of a tire model at the slip angle, wherein the characteristic curve corresponds to the road friction coefficient.

In addition to one or more of the features described herein, the processor is further configured to calculate the wheel stiffness by calculating a derivative from values in a lateral force table for the wheel.

In addition to one or more of the features described herein, the processor is further configured to calculate a system dynamics matrix for the vehicle using the wheel stiffness and optimize the system dynamics matrix to generate the steering command.

In addition to one or more of the features described herein, one of the wheel is a front wheel and the wheel stiffness is a front wheel stiffness and the wheel is a rear wheel and the wheel stiffness is a rear wheel stiffness.

In addition to one or more of the features described herein, the vehicle is operated in a non-linear range of operation.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle with a trajectory planning system associated with the autonomous vehicle, In accordance with an exemplary embodiment;

FIG. 2 shows a block diagram illustrating an architecture for model predictive control, in an embodiment;

FIG. 3 shows a block diagram illustrating operation of the model predictive control, in an embodiment;

FIG. 4 shows a tire model illustrating relations between lateral and slip angle for a plurality of road friction coefficients;

FIG. 5 shows a flowchart of a process for operating a vehicle or providing a steering command to the vehicle; and

FIG. 6 shows a graph of lateral error of a vehicle using different control methods.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

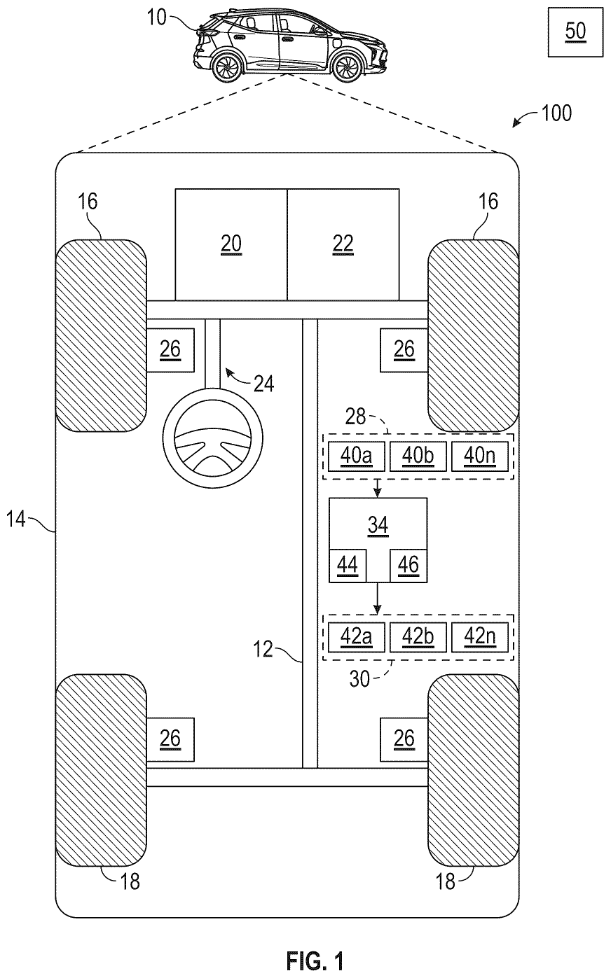

In accordance with an exemplary embodiment, FIG. 1 shows an autonomous vehicle 10 with a trajectory planning system 100 associated with the autonomous vehicle. In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The front wheels 16 and rear wheels 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle 10 can assist the driver through a number of methods, such as warning signals to indicate upcoming risky situations, indicators to augment situational awareness of the driver by predicting movement of other agents warning of potential collisions, etc. The autonomous vehicle 10 has different levels of intervention or control of the vehicle through coupled assistive vehicle control all the way to full control of all vehicle functions. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, and a controller 34. The propulsion system 20 may, in various embodiments, include an internal combustion engine, an electric machine such as a traction motor, and/or a fuel cell propulsion system. The transmission system 22 is configured to transmit power from the propulsion system 20 to the front wheels 16 and rear wheels 18 according to selectable speed ratios. According to various embodiments, the transmission system 22 may include a step-ratio automatic transmission, a continuously variable transmission, or other appropriate transmission. The brake system 26 is configured to provide braking torque to the front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc. The sensing devices 40a-40n can also sensor for detecting vehicle dynamics, such as a speedometer, an accelerometer, wheel rotation speed sensor, steering angle sensor, a slip angle sensor, etc.

The actuator system 30 includes one or more actuator devices 42a-42n that control one or more vehicle features such as, but not limited to, the propulsion system 20, the transmission system 22, the steering system 24, and the brake system 26. The steering system 24 can include a steering actuator that controls a steering angle of the vehicle or a steering angle of a wheel of the vehicle. In various embodiments, the vehicle features can further include interior and/or exterior vehicle features such as, but not limited to, doors, a trunk, and cabin features such as ventilation, music, lighting, etc. (not numbered).

The controller 34 includes a processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms disclosed herein.

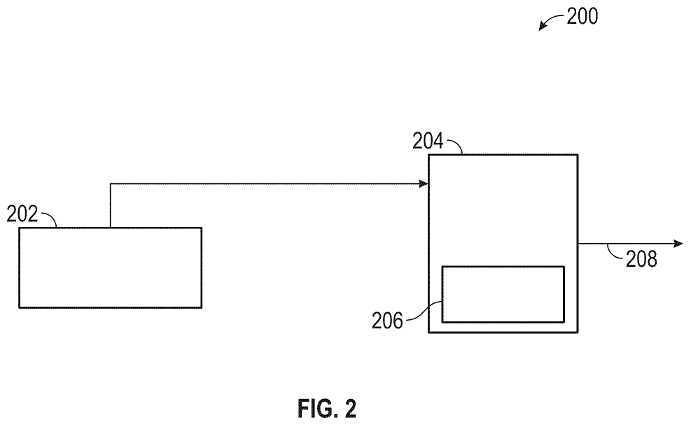

FIG. 2 shows a block diagram 200 illustrating an architecture for model predictive control, in an embodiment. The model predictive control can be performed at a processor of the controller 34. The block diagram 200 is relevant when the vehicle is in a linear range of operation. The linear range of operation includes standard driving operations such as city or highway driving. State measurements 202 are provided to a model predictive control 204. The state measurements are received from various sensors (such as sensing devices 40a-40n) of the vehicle. The state parameters can include, but are not limited to, a longitudinal velocity vₓ, a lateral velocity v_{y}, a longitudinal acceleration ax, a lateral acceleration ay, a yaw rate ψ of the vehicle, a slip angle α of a tire, etc. The model predictive control 204 outputs a control input or steering command 208 based on the state parameters.

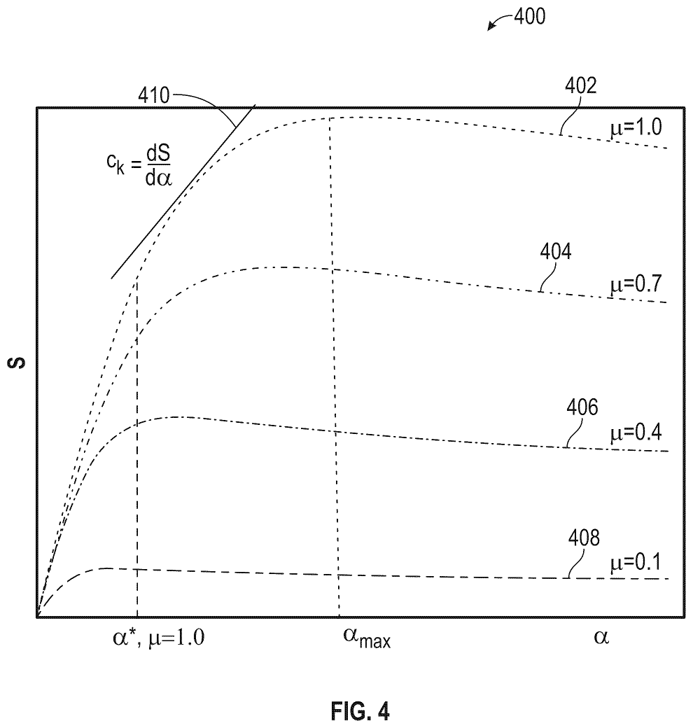

The model predictive control 204 solves a bicycle model 206 that represents the vehicle. The bicycle model 206 is a two-wheel model. A front wheel of the bicycle model 206 represents the front wheels of the vehicle, and a back wheel of the bicycle model represents the rear wheels of the vehicle. The front wheel of the bicycle model 206 is characterized by a front wheel tire stiffness c_{f} and the rear wheel of the bicycle model is characterized by a rear wheel tire stiffness cᵣ. In a linear range of operation, the front wheel tires stiffness c_{f} and the rear wheel tire stiffness cᵣ can be assumed to be constant values. This can be seen in the slope of characteristic curves in the tire model shown in FIG. 4 at low slip angle

The model predictive control executes an algorithm for calculating a steering command 208 at each of a plurality of prediction steps. The prediction steps are separated by ΔT milliseconds. The model predictive control predicts p steps ahead of a current state of the system or vehicle, where p is referred to as the prediction horizon. In an illustrative embodiment, p=20. A prediction is made at each of k prediction steps, where k=1, . . . , p.

For each prediction step k, the model predictive control 204 receives the state parameters and wheel stiffnesses. System dynamics matrices are then calculated using the state parameters and the stiffness parameters c_{f}, cᵣ, as shown in Eq. (1):

$$[ {A}_{k + 1} , {B}_{k + 1} ] = F ( {\overline{x}}_{k} , {c}_{f} , {c}_{r} ) \qquad Eq . ( 1 )$$

where x̅ₖ is the state vector for the vehicle at prediction step k, A is a first dynamic matrix, and B is a second dynamics matrix. As seen in Eq. (1), the dynamics matrices are calculated for a subsequent prediction step k+1 and can be applied toward determining a state vector at the subsequent prediction step. The first dynamics matrix A is applied to current state parameters and the second dynamics matrix B is applied to control input, and shown in Eq. (2):

$$Δ \overline{x} ≡ G ( {\overline{x}}_{k} , {c}_{f} , {c}_{r} ) = {A}_{k + 1} {\overline{x}}_{k} + {B}_{k + 1} {\overline{u}}_{k} \qquad Eq . ( 2 )$$

where ūₖ is the input at prediction step k. The state vector at prediction step k+1 is then calculated using Eq. (3):

$${\overline{x}}_{k + 1} = {\overline{x}}_{k} + G ( {\overline{x}}_{k} , {c}_{f} , {c}_{r} ) Δ T \qquad Eq . ( 3 )$$

An optimization process is performed to generate or output a control input, such as a steering command 208, that can be used to control the vehicle.

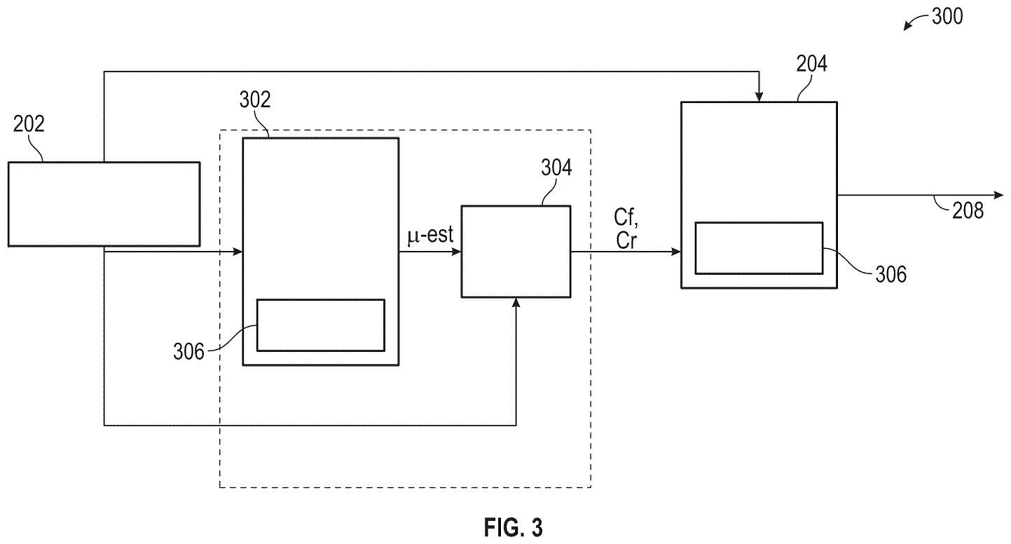

FIG. 3 shows a block diagram 300 illustrating operation of the model predictive control, in an embodiment. The various components of the block diagram 300 are performed at a processor of the controller 34 in a non-linear range of operation of the autonomous vehicle.

State measurements 202 are provided to the model predictive control 204. The state measurements 202 are provided to additional modules 302 including a road friction coefficient estimation module 304 and a wheel stiffness calculation module 306. The road friction coefficient estimation module 304 calculates an estimate of the road friction coefficient μ_est based on a current acceleration of the vehicle and a normal force of the vehicle.

The estimate of road friction coefficient μ_est involves the currently measured states (e.g., road wheel angle, slip angle, etc.) of the vehicle. The estimated road friction coefficient μ_est, as well as the state parameters (from state measurements 202), are provided to a wheel stiffness calculation module 306.

The wheel stiffness calculation module 306 outputs an estimate of a front wheel stiffness coefficient c_{f} and rear wheel stiffness coefficient cᵣ suitable for the current prediction step, using the methods disclosed herein. At each subsequent prediction step, the μ_est and c_{f}, cᵣ are re-calculated based on updated state parameters and updated road friction coefficient μ_est. The front wheel stiffness c_{f} and the rear wheel stiffness cᵣ are input to the model predictive control 204. The model predictive control 204 outputs a steering command 208 for the vehicle based on at least one of the front wheel stiffness c_{f} and the rear wheel stiffness cᵣ. The model predictive control 204 uses a non-linear bicycle model 308. The same non-linear bicycle model 308 is used in road friction coefficient estimation module 304.

The μ estimation and the estimation of the front wheel stiffness c_{f} and the rear wheel stiffness cᵣ are performed at each of a plurality of prediction steps during operation of the vehicle. Changes in any of these parameters at a k^{th} prediction step are therefore immediately captured in the next iteration of the model predictive control. The steering command 208 is therefore updated to be suitable for the current state of the vehicle.

FIG. 4 shows a tire model 400 illustrating relations between lateral and slip angle for a plurality of road friction coefficients. Slip angle (α) is shown along the abscissa and lateral force (S) is shown along the ordinate axis. A plurality of characteristic curves is shown. A first characteristic curve 402 represents the relation between lateral force and slip angle for a road friction coefficient of unity (μ=1.0). A second characteristic curve 404 represents the relation for μ=0.7. A third characteristic curve 406 represents the relation for μ=0.4. A fourth characteristic curve 408 represents the relation for μ=0.1. Each curve has a generally linear section at low values of slip angle and a non-linear section at values above a critical slip angle. A critical slip angle value α* for the first characteristic curve 402 is shown as well as a maximum slip angle value αₘₐₓ for the first characteristic curve 402. As the road friction coefficient decreases, the critical slip angle becomes smaller.

The tire model 400 can be representative of either the front wheel tire or the rear wheel tire of the bicycle model. For a selected characteristic curve (selected μ) and for a given slip angle α, the wheel stiffness is given by the slope of the characteristic curve at the slip angle. Each wheel stiffness is therefore given mathematically by Eq. (4):

$${C}_{k} = \frac{\partial S}{\partial α} ( \overline{x} , {F}_{z} , μ , α ) \qquad Eq . ( 4 )$$

where Eq. (4) represents a first equation in which a tire model for the front tire is used to determine the front wheel stiffness and a second equation in which a tire model for the rear tire is used to determine the rear wheel stiffness. The wheel stiffness Cₖ can be either a front wheel stiffness C_{f}_{ₖ} or a rear wheel stiffness Cᵣ_{ₖ}. In one embodiment, the derivative can be determined analytically from the graph by selecting an appropriate characteristic curve and slip angle, as illustrated by slope 410.

In a second embodiment, the slope can be generated by calculating a derivative at the slip angle using a lateral force table, such as one provided by a supplier of the tire. The lateral force table includes values from the tire model. For a lateral slip angle α, the lateral force can be read at the table for a slip angle α+ε and for a slip angle α-ϵ. The derivative of the tire core cₖ can be calculated as shown in Eq. (5):

$${C}_{k} = ( S ( α + ϵ ) - S ( α - ϵ ) ) / 2 ϵ \qquad Eq . ( 5 )$$

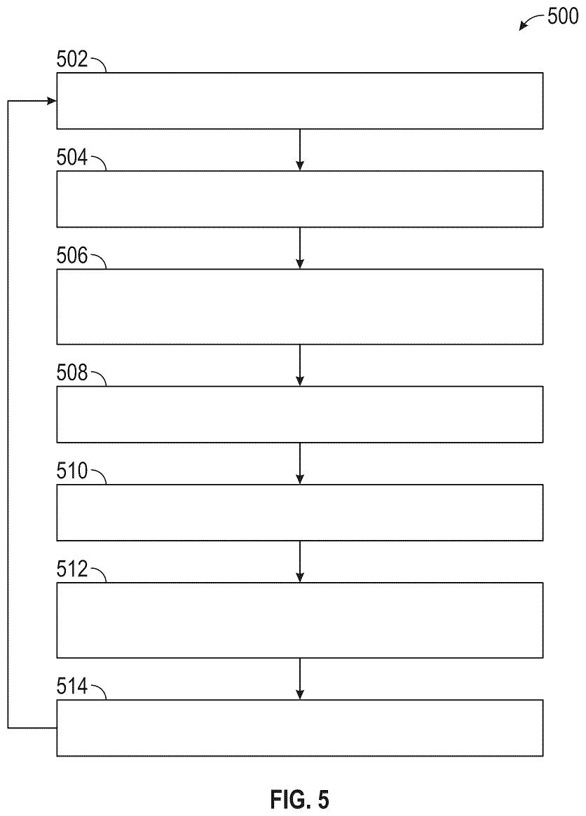

FIG. 5 shows a flowchart 500 of a process for operating a vehicle or providing a steering command to the vehicle. In box 502, one or more state parameters of the vehicle as well as a road friction coefficient for a tire of the vehicle are obtained at a first prediction step. The state parameters can include accelerations, steering angles, etc. In box 504, a normal force F_{z} of the vehicle and a slip angle for the vehicle are calculated at the first prediction step from the state parameters, such as from the accelerations.

In box 506, a wheel stiffness is calculated for a bicycle model representative of the vehicle. The wheel stiffness is at least one of the front wheel stiffness and the rear wheel stiffness. The wheel stiffness is calculated by calculating a derivative of a characteristic curve of a tire model at the slip angle. The characteristic curve corresponds to the road friction coefficient. In box 508, the wheel stiffness is input to the model predictive control which detections system dynamics matrices. In box 510, the system dynamics matrices are used to calculate a working point for the vehicle at a second prediction step (or next prediction step). In box 512, a control input for the vehicle is determined from an optimization process using the system dynamics matrices and the working point at the second prediction step. In box 514, the vehicle is operated using the generated control input. In an example, the control input is a steering command and the steering system is operated using the steering command. From box 514, the method can then return to box 502 to determine a steering command for a subsequent prediction step.

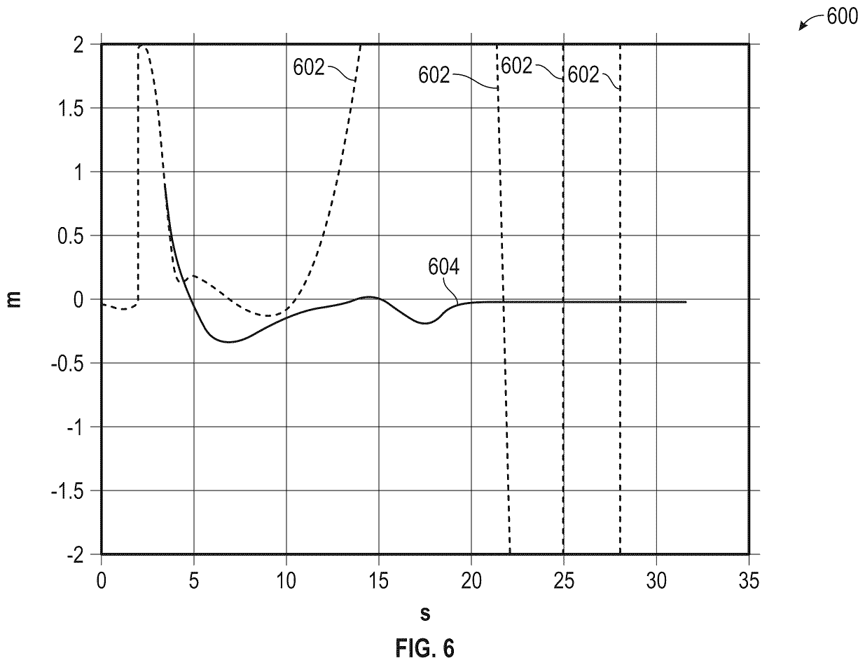

FIG. 6 shows a graph 600 of lateral error of a vehicle using different control methods. Time is shown along the abscissa in seconds (s) and lateral error is shown along the ordinate axis in meters (m). A first curve 602 shows lateral error when the vehicle is operating in a non-linear range and the steering command is generated using a linear approximation of control parameters. The first curve 602 shows that the lateral error varies erratically with wide fluctuations that extend beyond of the displayed range of the graph 600, thereby indicating loss of control. A second curve 604 shows lateral error when the vehicle is operating in a non-linear range and the steering command is generated using non-linear control parameters determined using the methods disclosed herein. The second curve 604 shows improved control of the vehicle.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
determining a slip angle of a wheel of the vehicle at a selected prediction step during operation of the vehicle;
determining a road friction coefficient of the wheel;
measuring an acceleration of the vehicle at the selected prediction step;
calculating a normal force for the vehicle at the selected prediction step from the acceleration;
determining a wheel stiffness for the wheel for the normal force at the slip angle using the road friction coefficient;
generating a control input for the vehicle using a model predictive control with the wheel stiffness as input; and
controlling, at a processor, the vehicle using the control input generated by the model predictive control.

2. The method of claim 1, further comprising calculating the wheel stiffness by determining a slope of a characteristic curve of a tire model at the slip angle, wherein the characteristic curve corresponds to the road friction coefficient.

3. The method of claim 1, further comprising calculating the wheel stiffness by calculating a derivative from values in a lateral force table for the wheel.

4. The method of claim 1, further comprising calculating a system dynamics matrix for the vehicle using the wheel stiffness and optimizing the system dynamics matrix to generate the control input.

5. The method of claim 1, wherein one of: (i) the wheel is a front wheel and the wheel stiffness is a front wheel stiffness; and (ii) the wheel is a rear wheel and the wheel stiffness is a rear wheel stiffness.

6. The method of claim 1, further comprising operating the vehicle in a non-linear range of operation.

7. The method of claim 1, further comprising determining the wheel stiffness and the slip angle from measurements obtained while the vehicle is being operated.

8. A system for operating an autonomous vehicle, comprising:
a sensor for measuring a state parameter of the autonomous vehicle, the state parameter including a slip angle of a wheel of the autonomous vehicle and an acceleration of the autonomous vehicle;
a processor configured to:
determine a road friction coefficient of the wheel at a selected prediction step from the state parameter;
calculate a normal force for the autonomous vehicle from the acceleration;
determine a wheel stiffness for the wheel for the normal force at the slip angle using the road friction coefficient;
generate a control input for the autonomous vehicle using a model predictive control having the wheel stiffness as input; and
control the autonomous vehicle using the control input generated by the model predictive control.

9. The system of claim 8, wherein the processor is further configured to calculate the wheel stiffness by determining a slope of a characteristic curve of a tire model at the slip angle, wherein the characteristic curve corresponds to the road friction coefficient.

10. The system of claim 8, wherein the processor is further configured to calculate the wheel stiffness by calculating a derivative from values in a lateral force table for the wheel.

11. The system of claim 8, wherein the processor is further configured to calculate a system dynamics matrix for the autonomous vehicle using the wheel stiffness and optimize the system dynamics matrix to generate the control input.

12. The system of claim 8, wherein one of: (i) the wheel is a front wheel and the wheel stiffness is a front wheel stiffness; and (ii) the wheel is a rear wheel and the wheel stiffness is a rear wheel stiffness.

13. The system of claim 8, wherein the vehicle is operated in a non-linear range of operation.

14. The system of claim 8, wherein the processor is further configured to determine the wheel stiffness and the slip angle from measurements obtained while the autonomous vehicle is being operated.

15. An autonomous vehicle, comprising:
a slip angle sensor for measuring a slip angle of a wheel of the autonomous vehicle;
an accelerometer for measuring an acceleration of the autonomous vehicle;
a steering actuator for controlling a steering angle of the autonomous vehicle;
a processor configured to:
determine a road friction coefficient of the wheel at a selected prediction step;
calculate a normal force for the autonomous vehicle from the acceleration;
determine a wheel stiffness for the wheel for the normal force at the slip angle using the road friction coefficient based on a tire model for the wheel;
calculate a steering command for the autonomous vehicle using a model predictive control having the wheel stiffness as input; and
control the steering actuator using the steering command to steer the autonomous vehicle.

16. The autonomous vehicle of claim 15, wherein the processor is further configured to calculate the wheel stiffness by determining a slope of a characteristic curve of a tire model at the slip angle, wherein the characteristic curve corresponds to the road friction coefficient.

17. The autonomous vehicle of claim 15, wherein the processor is further configured to calculate the wheel stiffness by calculating a derivative from values in a lateral force table for the wheel.

18. The autonomous vehicle of claim 15, wherein the processor is further configured to calculate a system dynamics matrix for the vehicle using the wheel stiffness and optimize the system dynamics matrix to generate the steering command.

19. The autonomous vehicle of claim 15, wherein one of: (i) the wheel is a front wheel and the wheel stiffness is a front wheel stiffness; and (ii) the wheel is a rear wheel and the wheel stiffness is a rear wheel stiffness.

20. The autonomous vehicle of claim 15, wherein the vehicle is operated in a non-linear range of operation.
